(19) United States
(12) Patent Application Publication
(10) Pub. No.: US 2010/0099391 A1
(43) Pub. Date: Apr. 22, 2010

(54) VOICE TICKETING

(75) Inventors: Narada Warakagoda, Strommen (NO); Juan Carlos López Calvet, Oslo (NO); Knut Kvale, Skedsmokorset (NO)

Correspondence Address: BIRCH STEWART KOLASCH & BIRCH, PO BOX 747, FALLS CHURCH, VA, 22040-0747, US

(73) Assignee: TELENOR ASA, FORNEBU (NO)

(21) Appl. No.: 12/528,247

(22) PCT Filed: Feb. 22, 2008
(86) PCT No.: PCT/NO08/00067

§ 371 Date: Aug. 21, 2009

(30) Foreign Application Priority Data
Feb. 23, 2007 (NO) 20071037

(51) Int. Cl. H04W 4/24; G10L 13/00; H04M 3/42; H04W 4/14; G06F 17/00

(52) U.S. Cl. 455/414.1; 704/260; 455/466; 235/375; 704/E13.001

(57) ABSTRACT

The invention relates to a method and a system for performing an e-commerce transaction between a user and a provider for a service or product by using a wireless communication terminal comprising a contactless reader. The method comprises the step of receiving a transaction request from the communication terminal, the transaction request being initiated by the contactless reader reading primary information about the service or product from an information tag. The transaction request contains also user information retrieved from the secure element. Next, a speech based dialog is initiated with the user through the communication terminal based on the transaction request, resulting in secondary information about the service or product. Next, a transaction is initiated, based on the primary and secondary information. Finally, a confirmation message may be sent to the communication terminal or to the provider.

### FIELD OF THE INVENTION

The present invention relates in general to wireless communication and transactions. More specifically, the present invention relates to a method and a system for performing a transaction between a user and a service or product provider. The invention also relates to a method and a wireless communication terminal for initiating such a transaction.

### SUMMARY OF THE INVENTION

The present invention is defined in the independent claims. Various embodiments consistent with the principles of the invention are defined in the dependent claims.

### BRIEF DESCRIPTION OF THE DRAWINGS

In the following, the principles of the present invention will be described by example with reference to the enclosed drawings, where:

FIG. 1 is a diagram illustrating different elements used in connection with a first embodiment;

FIG. 2 is a diagram showing details of a wireless communication terminal, an RFID tag and a transaction system according to the first embodiment;

FIG. 3 is a flow chart illustrating a method according to the invention, performed by a transaction system; and

FIG. 4 is a flow chart illustrating a method according to the invention, performed by a wireless communication terminal.

### DETAILED DESCRIPTION OF THE INVENTION

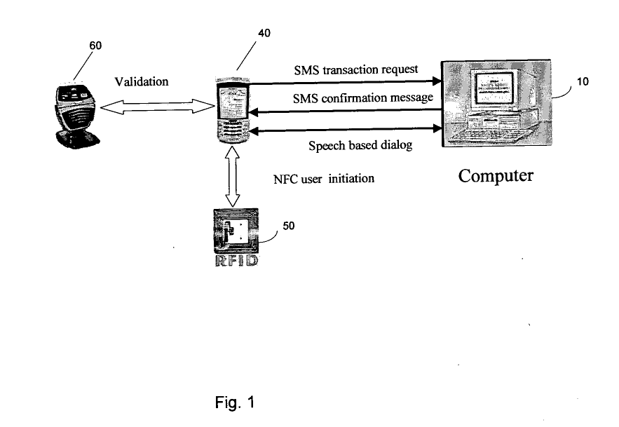

FIG. 1 is a schematic diagram illustrating different elements used in connection with a first embodiment. FIG. 1 shows a wireless communication terminal 40 such as a mobile telephone, which comprises a contactless reader. Consistent with principles of the invention, the wireless communication terminal may be equipped with a near field communication (NFC) reader or transceiver. FIG. 1 also shows a radio frequency identification (RFID) tag 50 that may be read by the contactless reader in the terminal 40. Also shown is a transaction system 10 which is operable to communicate with the wireless communication terminal 40. In an aspect of the invention, this communication is achieved by means of regular mobile communication features, including messages and voice. Also shown in FIG. 1 is an RFID/NFC reader 60 acting as a validating device, which may communicate with the wireless communication terminal by means of NFC communication, e.g. provided by the contactless reader/transceiver.

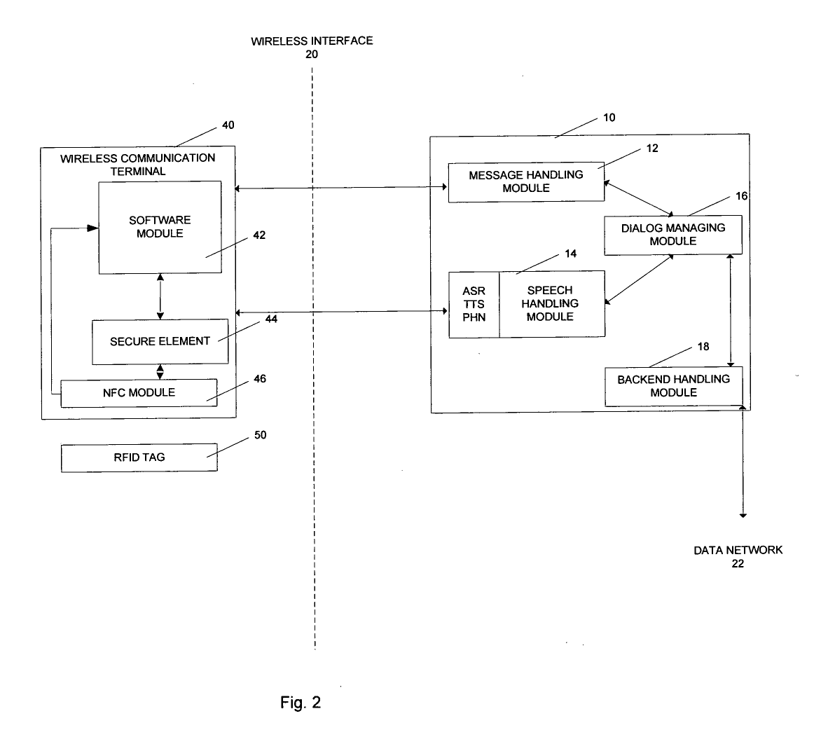

FIG. 2 is a schematic diagram showing details of a wireless communication terminal, an RFID tag and a transaction system according to the first embodiment.

The transaction system 10 may comprise four main software modules with hardware support. FIG. 2 shows an example where the system 10 comprises a message handling module 12 and a speech handling module 14 which are connected to a dialog managing module 16. The dialog managing module 16 is further connected to a backend handling module 18.

The modules 12, 14, 16 and 18 included in the transaction system 10 may for example be installed on a computer device or server which provides communication via a wireless network such as the GSM mobile phone communication network over wireless interface 20, and via a data communication network such as the Internet or an intranet over interface 22.

A wireless communication terminal 40 can connect to the system 10 to initiate a transaction, for example an e-commerce transaction, which will be described in further detail below. In the present embodiment, the wireless communication terminal 40 is a mobile phone where a software module 42 is installed. The mobile phone also contains a secure element 44 such as a smart card. A smart card can be a subscriber identity module (SIM) card or a similar module such as a USIM (universal mobile telecommunication system SIM) or a universal integrated circuit card (UICC) or a proprietary module such as SmartMX or other types of smart cards. It should be noted that the invention is not limited to the types of secure elements mentioned above.

The software module 42 is configured to communicate with the secure element 44 and a near field communication (NFC) module 46, and it is also configured to communicate via the wireless interface 20. The NFC module 46 provides the ability to read information from an RFID tag 50 (See FIG. 1.)

Further details regarding the system 10, used in certain aspects of the invention, will now be described. As used in this specification, the word “user” refers to for example a customer who wants to purchase a product or service. It can also refer to for example a person who wants to obtain information. The word “provider” refers to for example a vendor of products and services. It can also refer to for example an information provider.

The message handling module 12 is capable of receiving and sending messages to a specific wireless communication terminal via the wireless interface 20. According to the present embodiments the messages may be SMS (Short Message Service) or MMS (Multimedia Messaging) messages.

The speech handling module 14 comprises three submodules:
1. The ASR (Automatic Speech Recognition) module transforms a speech signal to data, for example a word string, which can be interpreted by the dialog managing module 16.
2. The TTS (Text-To-Speech synthesis) module that transforms a text string to a speech signal which can be interpreted by a person.
3. The PHN (Telephony) module that includes telephony functionality such as starting and stopping a call, sending and receiving speech to/from the wireless communication terminal.

In addition, speech handling module 14 comprises the necessary functionality to send or receive data to/from the dialog managing module 16.

The dialog managing module 16 controls the whole interaction between the wireless communication terminal and the system 10, i.e. it is this module that determines the next step of the system, using a finite state machine and the information it has received so far. In an aspect of the invention, the dialog handling module comprises a finite state machine controlling the speech handling module such that when the state machine is initiated to a first state, the finite state machine is configured to, upon reception of the transaction request, transit to a second state. The transition is at least partially dependent on the transaction request, meaning that it may comprise one or more intermediary state transitions before it enters the second state, and that these one or more state transitions are based on parts or whole of the transaction request. In the second state, the finite state machine is configured to commence the speech based dialog.

The dialog manager module 16 also formulates questions in order to obtain required information from a user.

The backend handling module 18 provides communication with external services, such as databases, banking systems etc. via the data communication network 22.

The method for performing a transaction will now be described with reference to FIGS. 1, 2 and 3.

In accordance with the present exemplary embodiment, the user may be using his/her communication terminal 40 to buy, for example, a bus ticket from a bus ticket provider. The transaction is initiated when the user is moving the NFC module 46 of the communication terminal near an RFID tag 50 located at the bus stop. The RFID tag comprises information, hereinafter denoted primary information, about the provider and about the current location. In general, the RFID tag can contain any provider or service related, but user independent, information. Certain primary information is used to determine how the transaction is initiated, and certain primary information becomes a part of the transaction request it self. For example if the RFID tag contains a command for sending an SMS and a service access number, the reading of the RFID tag 50 initiates the software module 42 to send a transaction request as an SMS to the system 10 via the wireless interface 20. The transaction request is formed by combining certain primary information read from the RFID tag 50 and user information, such as the user's preferences and profile etc. extracted from the secure element 44. In this example, the transaction request contains the current location (extracted from the RFID tag) and the user's payment preference and information such as credit card number (extracted from the secure element).

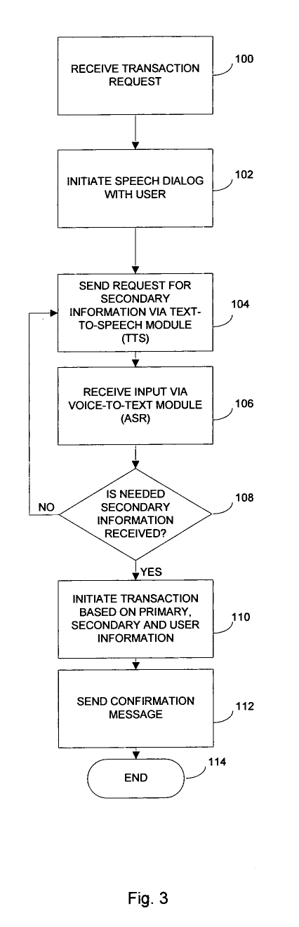

FIG. 3 is a flow chart illustrating a method for performing a transaction between a user and a provider according to the invention, performed by a transaction system.

In a first step 100, the message handling module 12 of the system 10 receives a transaction request from the wireless communication terminal. The transaction request has been initiated by the contactless reader reading primary information about a service or a product from an information tag.

The transaction request includes the primary information about the service or product, which has been read from the information tag. In an aspect of the invention, the primary information comprises information which identifies the provider.

In another aspect of the invention, the transaction request further comprises user information which has been retrieved from a secure element in the wireless communication terminal.

The primary information and user information are transferred to the dialog managing module 16, which, based on the received information, determines a secondary information that is required from the user to finish the transaction.

The secondary information may comprise price information of the products or services in question. Price information may be needed in for example the scenario where the received information doesn't comprise information about the age of the user, but where ticket prices vary according to passenger age. Alternatively or in addition, the secondary information may comprise quantity information indicating the number of products or services, for example the number of tickets to be bought. Alternatively or in addition, the secondary information may comprise quality information that specifies further attributes of the products or services, for example information about whether the user wants a return ticket or a one-way ticket.

In steps 102-108, a speech based dialog with the user through the communication terminal based on the transaction request is initiated and controlled, resulting in secondary information about the service or the product.

In an aspect of the invention, the speech based dialog comprises interpreting received speech information from the wireless communication terminal by means of automatic speech recognition. In another aspect of the invention, the speech based dialog comprises to send information to the wireless communication terminal using a text-to-speech synthesis which is based on the received primary or secondary information.

In step 102, the speech dialog with the user is initiated by the dialog managing module 16 via the speech handling module 14 as a call to the user through the communication terminal.

In step 104, the TTS module of the speech handling module 14 synthesizes a question from the dialog managing module 16 as speech to the user.

In step 106, the answer from the user is received and transformed by the ASR module to information that can be interpreted by the dialog managing module 16.

In step 108, the dialog managing module 16 evaluates the received answer. If all secondary information is received, the method continues to step 110, if not, the method jumps back to step 104 to ask more questions to the user.

In the above described case, primary information already contains the current location i.e. the departure bus stop. Since the system also needs to know the destination bus stop to perform the transaction the dialog may, for example, comprise the following question:

“Where are you traveling to?”

In step 110, a payment transaction is initiated from the dialog managing module 16 based on the received primary and secondary information. In an aspect of the invention the transaction is also initiated based on the received user information. The user information can be used to identify how the user prefers to pay for the service and the necessary parameters such as an account/credit card number. If, for example, the user prefers to use the credit card, the included credit card number may be charged.

The payment transaction process is performed by the backend handling module 18 which communicates with other databases or banking services. In one aspect of the invention, the user information can also be stored in a user information database as a part of the backend handling module 18.

In step 112, a confirmation message is sent to the user, i.e. to the wireless communication terminal. According to some embodiments of the invention, the confirmation message may be encrypted. In this example this message can serve as a ticket, depending on whether the transaction process was accepted or not. In an aspect of the invention the confirmation message is securely stored in the wireless communication terminal. The confirmation message may be securely stored in a memory in the wireless communication terminal, or in a secure element such as a smart card.

In an alternative aspect, the confirmation message may alternatively or additionally be sent to the provider, for example to a validation terminal.

The confirmation message may be in the form of an SMS or an MMS, or alternatively another type of message.

In a further aspect (not illustrated), the credit of the user may be checked before the confirmation message is sent.

In yet a further aspect (not illustrated) the confirmation message may be transferred from the wireless communication terminal to a system representing the provider as a receipt for the transaction. Examples of such a system include an electronic ticket reader on a bus or an automatic gate at a subway station.

The method ends at the terminating step 114.

When the confirmation message has been stored, the user can proceed to a validation terminal 60 (shown in FIG. 1), for example inside a bus, and the confirmation message can be transferred to the validation terminal where the ticket is read from the communication terminal. The validation terminal is a computing device equipped with an NFC reader. The user can initiate the validation process by touching his/her wireless communication terminal on the validation terminal's NFC reader. In this case, the NFC module 46 and the secure element 44 on the wireless communication terminal can act as an RFID/NFC tag and allows the stored confirmation message to be read. The validation terminal can then verify the validity of the confirmation message either by decrypting it or by other methods, such as calculating a checksum.

The validation terminal 60 may initiate a deleting action on the communication terminal to delete or amend the confirmation message stored on the secure element, to avoid that the same wireless terminal is used more times than allowed (in case tickets for more than one person is purchased). However, corresponding security measures may be provided in the validation terminal as well.

In the discussion above, it should be noted that several questions in the dialog between the system 10 and the user can be omitted by using the method and system according to the invention. Since the location already was sent as a part of the primary information from the RFID tag, the question “Where do you travel from?” is unnecessary. Alternatively or in addition, if payment preferences and related information such as an account/credit card number have been a part of the initial transaction request, the question “How do you prefer to pay?” becomes unnecessary, since this information is already available from the user information. Consequently, the secondary information exchange process may be reduced to a minimum, since information available to the wireless communication terminal 40 prior to the speech-based dialog is sent through the initiating transaction request.

In an aspect of the invention, omission of questions can be achieved by transiting the previously mentioned finite state machine from a first state in which no information about the transaction is known to a second state in which primary and secondary information provided in the transaction request is known. This assumes that the finite state machine can interpret the primary and secondary information. If the state machine receives primary or secondary information “X” it cannot interpret, it may transit to an error state in which for example the following response is given:

“I am sorry, but I don't understand X.”

It should be noted that in the embodiment described above, the secondary information may be limited to a predefined set of possible answers to a question, i.e. there may be a limited set of possible places to travel to from that bus stop. Moreover, the user can be prompted to choose from the predefined set of possible answers, for example:

“The neighborhood you are heading to has four bus stops. These are Elm Street, Dark Park, Swamp Lane, and Elk Street.”

The predefined set of possible answers are provided in the system 10, and the dialog managing module 16 can therefore compare the answer from the user with this limited set of possible answers. If it is not possible to distinguish between two or more elements in a subset of the predefined set, for example to distinguish between the two bus stops “Elm Street” and “Elk Street”, the dialog managing module 16 can give instructions to the speech handling module 14 to ask for the secondary information in a more precise way:

“Did you say Elm Street or Elk Street? Please say TREE if you mean Elm Street and say ANIMAL if you mean Elk Street.”

In accordance with these features of the invention, there is no need to use the buttons on the communication terminal to describe the product or service, e.g. as an SMS message. Many people, especially physically disabled persons such as people with dyslexia or visual impairments, will find the above method efficient and user-friendly.

In order to cause the transaction system to perform the above method, a memory in the transaction system may tangibly embody a set of instructions, configured to perform the above steps for performing a transaction between a user and a provider when the instructions are executed by a processing device in the transaction system. Such instructions may also be embodied on a propagated signal which is, e.g., transferred between computers or network elements in a communication network or a computer network.

It should be noted that in the discussion above, the RFID tag, or several RFID tags, may alternatively or in addition be integrated on the outside of the bus, for example next to the entrance(s) of the bus, or inside the bus, for example right next to the bus driver. Such an embodiment may increase the risk of “free riding” passengers, but can be more user-friendly for passengers who are always on the run when catching their bus. According to some aspects of such an embodiment of the invention, the primary information read from the onboard RFID tag(s) may contain the identity of the bus, and the dialog managing module 16 may retrieve the current location of the bus from an external bus positioning service via the backend handling module 18. This information may be used to determine the correct fare, while sparing the user the question:

“Where is the bus you are riding on located right now?”

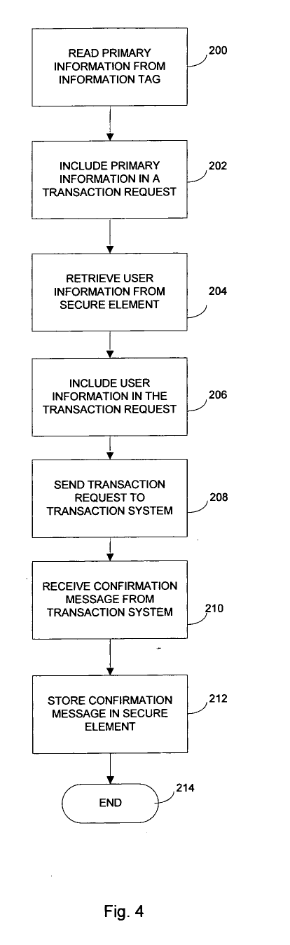

FIG. 4 is a flow chart illustrating a method for initiating an e-commerce transaction between a user and a provider by using a wireless communication terminal comprising a contactless reader, performed by a wireless communication terminal.

The method starts at the primary information reading step 200, wherein primary information about the service or product is read from an information tag by the contactless reader in the wireless communication terminal.

Next, in step 202, the primary information is included in a transaction request.

Next, in step 204, which is included in a certain aspect of the invention, user information is retrieved from a secure element in the wireless communication terminal.

Next, in step 206, which is also included in a certain aspect of the invention, the user information is included in the transaction request.

Next, in step 208, the transaction request is sent to a transaction system, such as the transaction system 10 illustrated in FIGS. 1 and 2. The transaction system is configured to control a speech based dialog with the user through the communication terminal based on the transaction request, in such a way that the speech based dialog results in secondary information about the service or product. The transaction system is further configured to initiate a payment transaction based on the primary and secondary information and to send a confirmation message to the communication terminal, or alternatively or additionally, to the provider.

In an aspect of the invention the method further comprises the step 210 of receiving the confirmation message from the transaction system.

Next, in an aspect of the invention, illustrated at step 212, the received confirmation message is stored in the secure element of the wireless communication terminal. The secure element may be a smart card.

The method ends at the terminating step 214.

In order to cause the wireless communication terminal to perform the above method, a memory in the wireless communication terminal may tangibly embody a set of instructions that are configured to perform the above steps for initiating an e-commerce transaction between a user and a provider for a service or product when the instructions are executed by a processing device in the wireless communication terminal. This set of instructions corresponds to the software module 42 illustrated in FIG. 2. Such instructions may also be embodied on a propagated signal which is, e.g., transferred between computers or network elements in a communication network or a computer network.

### ALTERNATIVE EMBODIMENT

In an alternative embodiment the scenario may be that a user stands next to an ATM machine and has forgotten a PIN code associated with e.g. a debit or credit card. The user may then use his wireless communication terminal to read a tag provided at the ATM machine, and the speech-based dialog is initiated as described above. In this embodiment, the primary information could for example be the provider's telephone number to which the wireless communication terminal should send a transaction request.

In this embodiment, the system 10 should preferably establish that an authorized user is holding the wireless communication terminal 40 and nobody else. Therefore, it may be preferred to configure the dialog managing module 16 to always require secondary information from the user, for example the answer to a personal question pre-stored in a database and accessible via the backend handling module 18. An example of such a personal question could be:

“What was the name of your first cat?”

Upon the wrong answer, the dialog may be aborted, or another pre-stored personal question may be asked.

Provided that the user is authorized, the user's PIN may be retrieved from a PIN database via the backend handling module and provided to the user as synthesized speech via the speech handling module 14, and/or as a message via the message handling module 12. Alternatively, the PIN is transferred only as synthesized speech and a confirmation message is sent to the user via the message handling module 12. The message could for example be:

“This is to confirm that your ATM machine PIN has been provided by us. If you believe that this message has been sent to you in error, please contact us immediately at . . . ”

This embodiment can be regarded as a pure information retrieval service, where the transaction comprises the transfer of information to the user. However, it should be noted that in this embodiment, the dialog managing module 16 may in addition also initiate a payment transaction before, during or after the transfer of the PIN to the user.

### OTHER ALTERNATIVE EMBODIMENTS

The dialog between the transaction system 10 and the user can be chosen in many ways, depending on the area of application. In the bus ticket example above, the system could ask more questions related to the number of persons that are traveling together, or whether the user(s) is below or over an age limit as secondary information for the transaction.

In an alternative embodiment, the PHN (Telephony) module optionally comprises DTMF tone recognition capability, thus enabling some parts of the information to be provided by the user to the dialog managing module 16 by entering the information on a keypad and transmitted as DTMF tones as additional information from the user instead of speech. It may be advantageous to provide such information particularly when providing numbers to the system 10, such as the number of tickets to buy or the age of the user. The question asked by the speech handling module could then for example be:

“How many people are traveling to Elm Street? Please say the number, or press the number on the keypad and terminate the number by pressing #.”

In another embodiment, the provider can be a hotel and an RFID tag can be provided on an advertisement. After the initiating request as described above, the dialog managing module 16 asks for the date(s) on which the user wants to stay at the hotel and other questions related to the stay (e.g. type of room, number of persons etc). Here, the possibly encrypted confirmation message can be sent as an SMS containing information such as a room number and a PIN code to access the room. Accordingly, no check-in is necessary, and an NFC based validation terminal mounted on the door can grant access to the user.

There are several security issues that should be considered in certain aspects of the invention. One very important security issue is that a fraudulent RFID can prompt a wireless communication terminal to connect to a non trusted system 10. Such a security risk may be avoided by maintaining a list of trusted service providers on the wireless communication terminal or at another trusted component in the network. The security related design choices are made when the system is implemented and depend on the nature of the particular use and purpose of the system. In the detailed example described above, an RFID based near field communication reader is used in the wireless communication terminal. Another type of contactless reader may alternatively be employed, such as an optical reader, e.g. a bar code reader. In such an example, a bar code reader may be used in the communication terminal to read a 2D bar code. In another alternative, the communication terminal comprises a digital camera which is used to take a picture of a 2D bar code. A picture recognition algorithm either in the software module 42 or in the message handling module 12 can transform the picture to extract the above mentioned primary information.

It is also possible to send the confirmation message as an MMS receipt containing a picture of a 2D bar code. A point of sale (PoS) terminal having a bar code reader will then read the bar code picture directly from an LCD display of the communication terminal to provide access to the service or product.

In the exemplary description above the modules 12, 14, 16 and 18 included in the transaction system 10 are installed on a single computer. Persons skilled in the art will realize that the transaction system does not necessarily have to be concentrated into one single computer. For instance, each module or a group of modules may be implemented with separate computer devices that intercommunicate using network/communication equipment that may be selected by the skilled person as necessary.

Although the wireless interface 20 has been exemplified as providing communication between the transaction system 10 and the wireless communication terminal 40 via the GSM mobile communication network, the skilled person will realize that other communication networks may be applicable for use with the present invention, e.g. a GPRS enabled GSM network, or a UMTS/3G mobile communication network. The wireless interface 20 may even involve the use of subnetworks that may be wired, such as the PSTN network, as well as subnetworks that provide local (short-range) wireless communication based on, e.g., Bluetooth, WLAN, Zigbee, WiMax, etc.

The abovementioned detailed description is especially provided to illustrate and to describe preferred embodiments of the invention. However, the description is by no means limiting the invention to the specific embodiments.

1-58. (canceled)

59. Method in a computerized transaction system for performing a transaction between a user using a wireless communication terminal comprising a contactless reader and a service or product provider, where the method comprises:
receiving a transaction request from the communication terminal, where the transaction request is initiated by the contactless reader reading primary information about the service or product from an information tag;
initiating a speech based dialog with the user through the communication terminal based on the transaction request, the dialog including requesting and receiving secondary information about the service or product from the user, the receiving comprising interpreting speech information transmitted by the wireless communication terminal, the interpreting being based on automatic speech recognition;
initiating at least one transaction based on the primary and secondary information.

60. Method according to claim 59, where said at least one transaction comprises payment via an external service, said payment being based on said primary and secondary information.

61. Method according to claim 59, where said at least one transaction comprises transferring information to the wireless communication terminal, the information being based on said primary and secondary information.

62. Method according to claim 61, where said information is provided to the user via the speech based dialog using text-to-speech synthesis.

63. Method according to claim 61, where said information is transmitted as an SMS or MMS.

64. Method according to any one of the preceding claims, where the method further comprises sending a confirmation message to at least one of the communication terminal and the provider.

65. Method according to claim 59, where the confirmation message is an SMS or MMS and where the confirmation message is securely stored in a memory in the wireless communication terminal or in a smart card in the wireless communication terminal.

66. Method according to claim 59, where the transaction request comprises the primary information about the service or product read from the information tag.

67. Method according to claim 66, where the transaction request further comprises user information retrieved from a smart card in the wireless communication terminal.

68. Method according to claim 59, where the transaction request is an SMS or MMS.

69. Method according to claim 59, where the speech based dialog further comprises sending information to the wireless communication terminal using text-to-speech synthesis based on the received primary or secondary information.

70. Method according to claim 59, where the contactless reader in the wireless communication terminal is a near field communication reader.

71. Method according to claim 59, where the secondary information is selected from the set of:
price information of products or services;
quantity information indicating the number of products or services; or
quality information specifying further attributes of products or services.

72. A set of instructions, tangibly embodied in a memory, a storage medium or on a propagated signal, configured to perform a method as set forth in claim 59 when the instructions are executed by a processing device in a transaction system.

73. System for performing a transaction between a user using a wireless communication terminal comprising a near field communication reader and a service or product provider, where the system comprises:
a message handling module for receiving messages from and sending messages to the communication terminal;
a speech handling module for performing a speech based dialog with the user through the communication terminal;
a dialog managing module configured to:
receive a transaction request from the communication terminal via the message handling module, where the transaction request comprises primary information about the service or product, and where the transaction request is initiated by a contactless reader reading the primary information from an information tag;
controlling a speech based dialog with the user through the communication terminal based on the transaction request via the speech handling module, the dialog including requesting and receiving secondary information about the service or product from the user, the receiving comprising interpreting speech information transmitted by the wireless communication terminal, the interpreting being based on automatic speech recognition, the secondary information being selected from the set of:
price information of the products or services;
quantity information indicating the quantity of the products or services; or
quality information specifying further attributes of the products or services;
initiating at least one transaction based on the primary and secondary information, where the at least one transaction comprises transferring information to the wireless communication terminal, the information being based on the primary and secondary information;
a backend handling module communicatively connected with at least one of a database or a banking service via a data communication network, the backend handling module being configured to upon initiating of the at least one transaction perform the at least one transaction at the database or banking service.

74. System according to claim 73, where the confirmation message is an SMS or MMS, and where the transaction request is an SMS or MMS.

75. System according to any one of claims 73-74, where the confirmation message is securely stored in a smart card in the wireless communication terminal.

76. System according to claim 73, where the transaction request further comprises user information retrieved from a smart card in the wireless communication terminal.

77. Method for initiating a transaction between a user and a service or product provider by using a wireless communication terminal comprising a contactless reader, the method comprising:
reading, by the contactless reader, primary information about a service or product from an information tag;
including said primary information in a transaction request;
sending the transaction request to a transaction system, causing the transaction system to initiate a speech based dialog with the user through the communication terminal based on the transaction request, the speech based dialog being based on automatic speech recognition and providing the transaction system with secondary information about the service or product, and further causing the initiating of a transaction based on the primary and secondary information;
receiving a confirmation message from said transaction system and storing said confirmation message in a smart card.

78. Method according to claim 77, further comprising:
retrieving user information from said smart card in the wireless communication terminal, and
including the user information in said transaction request.

79. A set of instructions, tangibly embodied in a memory, a storage medium or on a propagated signal, configured to perform a method as set forth in one of the claims 77-78 when the instructions are executed by a processing device in a wireless communication terminal.

80. A memory in a wireless communication terminal, containing a set of instructions as set forth in claim 79.

81. Wireless communication terminal, comprising a processing device and a contactless reader, the terminal being configured to perform a method for initiating a transaction between a user and a service or product provider as set forth in one of the claims 77-78.
